(19) United States
(12) Patent Application Publication
(10) Pub. No.: US 2020/0243050 A1
(43) Pub. Date: Jul. 30, 2020

(54) DEVICES AND SYSTEMS FOR ASSISTING WITH PERFORMANCE OF A PLUCKED STRING INSTRUMENT

(71) Applicant: SZ DJI TECHNOLOGY CO., LTD, Shenzhen City (CN)

(72) Inventors: You ZHOU, Shenzhen (CN); Cheng OUYANG, Shenzhen (CN); Minghao LI, Shenzhen (CN); Yumian DENG, Shenzhen (CN)

(73) Assignee: SZ DJI TECHNOLOGY CO., LTD., Shenzhen City (CN)

(21) Appl. No.: 16/786,338

(22) Filed: Feb. 10, 2020

Related U.S. Application Data
(63) Continuation of application No. PCT/CN2017/097631, filed on Aug. 16, 2017.

(51) Int. Cl. G10D 3/06; G10D 1/05; G09B 15/02

(52) U.S. Cl. CPC G10D 3/06; G09B 15/02; G10D 1/05

(57) ABSTRACT

Devices and systems for assisting with playing a plucked string instrument are provided. In some exemplary implementations, a device for providing assistance to operating a plucked string instrument may include a key positioned above a string of the plucked string instrument and attachable to a fretboard of the plucked string instrument. The key may be configured to apply a force to the string when the key is depressed. The device may also include a magnet located under the key and configured to generate a magnetic field that reduces an amount of force required to depress the key without the magnet. The device may be implemented in a fretboard cover or may be integrated into the plucked string instrument.

### CROSS-REFERENCE TO RELATED PATENT APPLICATIONS

This application is a continuation application of International Application No. PCT/CN2017/097631, filed Aug. 16, 2017, and entitled “DEVICES AND SYSTEMS FOR ASSISTING WITH PERFORMANCE OF A PLUCKED STRING INSTRUMENT,” which is herein incorporated by reference in its entirety.

### FIELD OF THE DISCLOSURE

This disclosure relates generally to plucked string instruments, and more specifically, to devices and systems that assist with playing such instruments.

### BACKGROUND

Plucked string instruments, such as guitars, are some of the most popular instruments in the world. Such instruments often include an elongated portion (“neck”) including an area with raised elements called “frets” over which strings are suspended. The area of the neck containing the frets is often referred to as a “fretboard.” Different musical notes and chords may be played by plucking or strumming the strings while also applying pressure to the strings at selected positions on the frets. However, excessive pressing of frets while playing can lead to sore fingers and even painful blisters and calluses on the player's fingertips. This may account for one of the reasons why many beginners quit learning guitar and other plucked string instruments after only a few lessons. There is a need for a device to minimize finger pain experienced while learning to play a plucked string instrument.

### SUMMARY

The present disclosure includes devices and systems that may assist with learning to play musical notes and chords on plucked string instruments in a manner that reduces or eliminates finger pain. As used herein, a “finger” refers to any natural or prosthetic body part or robotic device that may be used to play a plucked string instrument.

Certain embodiments of the present disclosure relate to a device for providing assistance to operating a plucked string instrument. The plucked string instrument may have a fretboard with a plurality of strings suspended over the fretboard. The device may comprise a key positioned above a string of the plurality of strings. The key may be attachable to the fretboard and adapted to apply a force to the string when the key is depressed.

Further to various disclosed embodiments, the device may be removably attached or integrated with the plucked string instrument. For example, the device may comprise a fretboard cover that connects or otherwise attaches to the neck or fretboard of the plucked string instrument. In other embodiments, the device may be fabricated as an integral part of the fretboard. Similarly, one or more magnets used by the device may be implemented as part of a device that attaches to a fretboard or integrated with the fretboard itself. In some embodiments, the magnets may be integrated with a bottom side of the fretboard or integrated within the thickness of the fretboard of the plucked string instrument.

Other embodiments of the present disclosure relate to a plucked string instrument. The instrument may comprise a fretboard having a plurality of frets located under a plurality of strings and at least one key located above the plurality of strings. The at least one key may be attachable to the fretboard, and each key may be adapted to apply a force to a string at the location of a fret when the key is depressed.

Still other embodiments of the present disclosure relate to a finger cuff adapted to fit over a finger of a player. The finger cuff may comprise a metal tip portion adapted to be positioned near a finger tip of the player when the player wears the finger cuff and a non-metal body portion adjacent to the tip portion. In some embodiments, the finger cuff may have a length that is not longer than the distance between a tip of a finger and a first joint of the finger of the musician. The metal portion of the finger cuff, when attracted by a magnetic field, may reduce the amount of force the player must apply to a string against a fret, or the amount of force to depress a key that presses a string against a fret, in the vicinity of the magnet. The finger cuff also may help the player learn to play notes and chords by guiding the player's finger to a magnet, such as an electromagnet, that generates a magnetic field behind a string-fret intersection corresponding to a correct note or chord.

There are many possible applications for the disclosed embodiments. Examples include, but are not limited to, acoustic, electric, and bass guitars, and other stringed instruments like ukele, mandolin, or banjo, among others. The inventive devices or systems disclosed herein may be attached or otherwise coupled to plucked string instruments or may be incorporated into the construction and/or assembly of such instruments. The disclosed devices and systems may permit easier self-teaching and valuable assistance for in-person music teachers.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims. It is to be understood that the foregoing general description and the following detailed description are exemplary and explanatory only, and are not restrictive of the disclosed embodiments.

### BRIEF DESCRIPTION OF DRAWINGS

The accompanying drawings, which comprise a part of this specification, illustrate several embodiments and, together with the description, serve to explain the disclosed principles. In the drawings:

FIG. 1 is a schematic diagram of an exemplary key that may be used in accordance with certain disclosed embodiments;

FIG. 2 is a schematic diagram of an exemplary fretboard including the exemplary keys of FIG. 1 that may be used in accordance with certain disclosed embodiments;

FIG. 3 is a schematic diagram of another exemplary fretboard including the exemplary keys of FIG. 1 that may be used in accordance with certain disclosed embodiments;

FIG. 4 is a schematic diagram of another exemplary key that may be used in accordance with certain disclosed embodiments;

FIG. 5 is a schematic diagram of an exemplary finger cuff that may be used in accordance with certain disclosed embodiments; and

FIG. 6 is a schematic diagram of an exemplary control circuit that may be used in accordance with certain disclosed embodiments.

### DETAILED DESCRIPTION

The disclosed embodiments relate to a device and system for assisting a person as he/she plays a plucked string instrument. Embodiments of the present disclosure may be implemented using one or more acoustic plucked string instruments, e.g., guitar, mandolin, banjo, etc., or alternatively, one or more electric plucked string instruments, e.g., electric guitar, electric bass, etc. Unlike conventional methods of playing plucked string instruments, the devices and systems in the disclosed embodiments allow for playing a plucked string instrument with reduced finger pain. The disclosed embodiments also may be used as teaching aids, e.g., which can be integrated with the plucked string instrument.

The devices and systems in certain disclosed embodiments include a fretboard with a plurality of frets and a plurality of strings suspended over the frets. The fretboard may be integrated into the plucked string instrument or may be removably attached to a neck or other portion of the instrument. Some disclosed embodiments also include a plurality of keys that are located above the strings. Each key is adapted to apply a force (or, equivalently, a pressure) on a string at the location of a fret when the key is depressed. In some embodiments, the keys are removable and/or may be repositioned along the strings to align with frets on the fretboard.

In accordance with some embodiments, a plurality of magnets, such as permanent magnets or electromagnets, are located underneath or within the fretboard and are adapted to attract a metal portion of a key and/or a metal portion of a finger cuff on the player's finger, such that less force is required for the player to depress the key or string when playing a note or chord on the plucked string instrument. In some embodiments, each finger cuff may include a metal portion and a body portion, such as formed of plastic, rubber, silicone, or the like, although other finger-cuff constructions are possible provided they contain a metallic portion that can be attracted to a magnet underneath the fretboard. The metal portion may be part of the body portion, such as a region of the body portion containing at least some metal, or may be separately constructed for combination with the body portion, e.g., attached to the body portion. In other disclosed embodiments, one or more electromagnets located under the fretboard may be selectively energized, e.g., by a control unit, to generate magnetic fields that assist with moving their corresponding keys up and down over the strings and/or attract finger cuffs on a player's fingers, thereby reducing or eliminating the force that a player otherwise would need to apply for pressing a string against a fret when playing a note or chord.

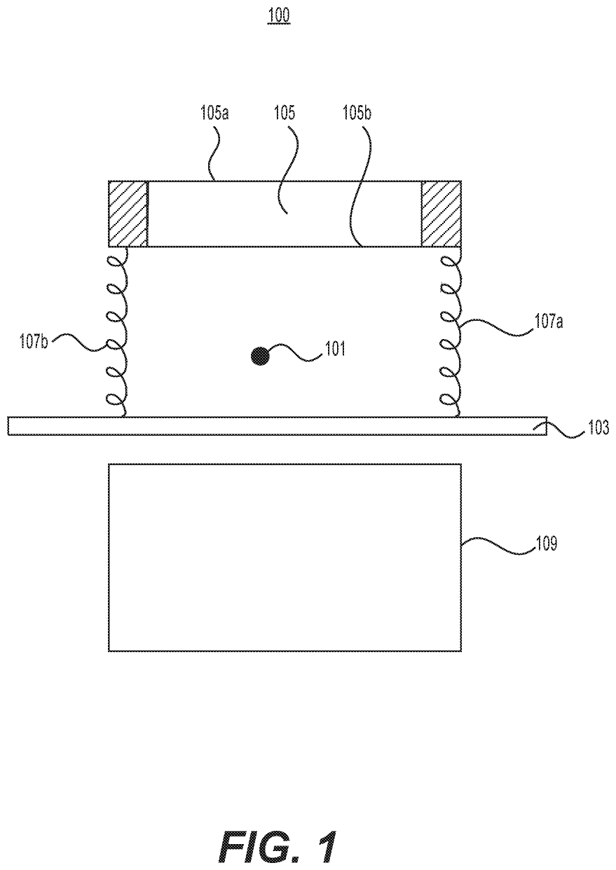

FIG. 1 depicts an exemplary key 100 that may be used in accordance with the disclosed embodiments. Key 100 may be attached to fretboard 103 in various ways, such as but not limited to using one or more screws, snap-on mechanisms, glues or other adhesives, magnets, and/or other means for securing the key 100 to the fretboard. In some embodiments, key 100 may be removably attached to fretboard 103, for example, via a latch, a snap-on mechanism, one or more magnets, one or more screws, or the like.

The exemplary key 100 may be located above a string 101 of a plucked string instrument. String 101 may be suspended above a fretboard 103 in a conventional manner, e.g., between a tuning peg and a bridge. In some embodiments (for example, if fretboard 103 is a portion of a guitar, a mandolin, or the like), key 100 may be located above a fret on fretboard 103 and may apply a force on the string 101 against the fret when the key 100 is depressed. In other embodiments (for example, if fretboard 103 is a portion of a violin, a voila, or the like), fretboard 103 may not include frets. Instead, key 100 may be located above a predetermined location on fretboard 103 and may apply a force on the string 101 against the predetermined location of the fretboard when the key 100 is depressed.

As depicted in FIG. 1, the key 100 may be aligned so it is approximately centered relative to the string 101. In alternative embodiments, the key 100 may be off-center from the string 101.

As further depicted in FIG. 1, key 100 may include a keytouch 105 including an outer surface 105a and an inner surface 105b. In some embodiments, outer surface 105a may be formed of a plastic, a metal, a wood, or any combination thereof. Outer surface 105a may be circular, oval, square, rectangular, or any other appropriate shape. Moreover, outer surface 105a may be flat or curved (e.g., shaped like a or an ‘n’). Outer surface 105a may further have a particular size which may, for example, be adapted to provide a sufficient touch area for a tip of a finger.

In some embodiments, outer surface 105a may be smooth. In other embodiments, outer surface 105a may be textured (e.g., rough, patterned, or the like) or coated with a material to provide enhanced friction or tactile feedback. The texturing or coating of outer surface 105a may be adapted to select a particular value for the coefficient of friction of outer surface 105a. The amount or type of texturing or coating may be selected, for example, based on the player's experience level.

In some embodiments, outer surface 105a may have a particular color, e.g., by selection of a material, paint, stickers, etc. For example, the outer surface 105a may be adapted to glow in the dark. By way of further example, the color of outer surface 105a may be adapted to match that of the fretboard 103 so they key 100 is less noticeable to an audience.

Key 100 also may include springs 107a and 107b that prevent the key from applying a force on string 101 when the key is not depressed. Springs 107a and 107b may be made of steel, titanium, copper, or any other appropriate metal, or a plastic, or a combination of metal and plastic. In other embodiments, rather than springs 107a and 107b, the key 100 may include any other appropriate device or mechanism that allows the key to move downward to a “pressed” position, for example when a force is applied to outer surface 105a, and move upward to a “released” position when the applied force is removed. The applied force may be from an electric or magnetic field or a force applied by a player's finger, or any combination thereof. In some embodiments, key 100 may comprise a biased switch. Accordingly, the spring constant of springs 107a and 107b may be selected such that key 100 forms a biased switch. In some embodiments, the spring constant of springs 107a and 107b may vary depending on the skill level of the player. For example, the spring constant may be higher for more advanced players.

In the example of FIG. 1, key 100 may include or be associated with a magnet 109, such as an electromagnet, positioned under a fret or at a predetermined position on the fretboard 103 and aligned with the inner surface 105b of the keytouch 105. In some embodiments, the inner surface 105b may be adapted to be attracted to magnet 109 and may include a metal, such as a ferromagnetic material like iron, nickel, or cobalt. In such embodiments, the attraction between magnet 109 (when energized if it is an electromagnet) and inner surface 105b may be adapted to reduce the force required to depress key 100 without the magnetic field (i.e., move the key to its “pressed” position, thereby applying a force on string 101 against a fret) and also may ensure key 100 remains a biased switched—that is, key 100 does not require an additional applied force to return to its initial “released” position.

The strength of magnet 109 may be varied. For example, the strength of magnet 109 may be selected depending on the skill level of the player. For example, a magnet 109 having a stronger magnetic field may be used for less advanced players. In some embodiments, magnet 109 may be positioned under one or more keys 100. In some embodiments, magnet 109 may be moved to different positions relative to the fretboard, and may be moved separately or together with one or more keys 100.

Some embodiments may not include magnet 109. For example, key 100 may function as a biased switch using only springs 107a and 107b.

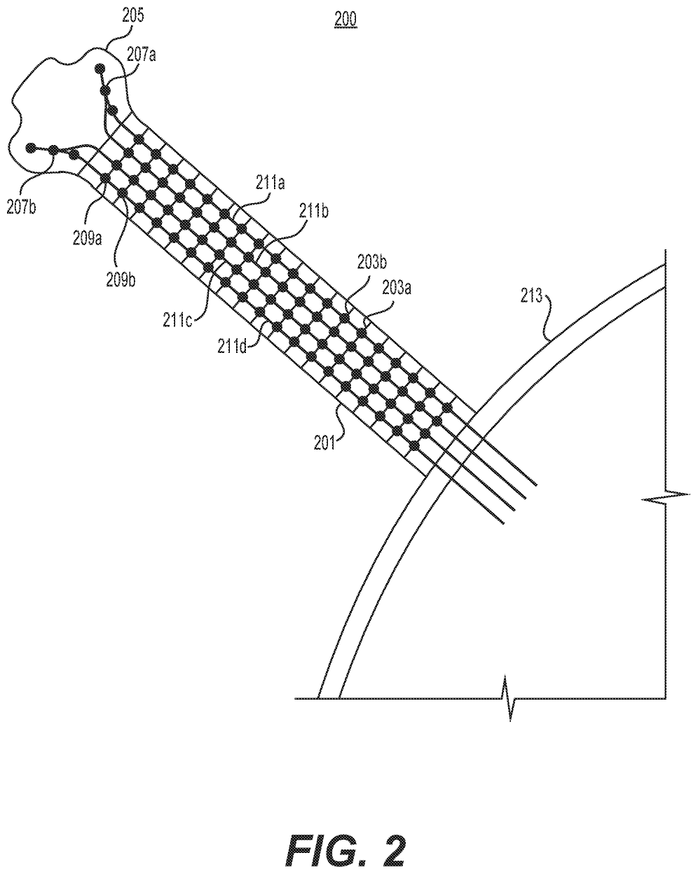

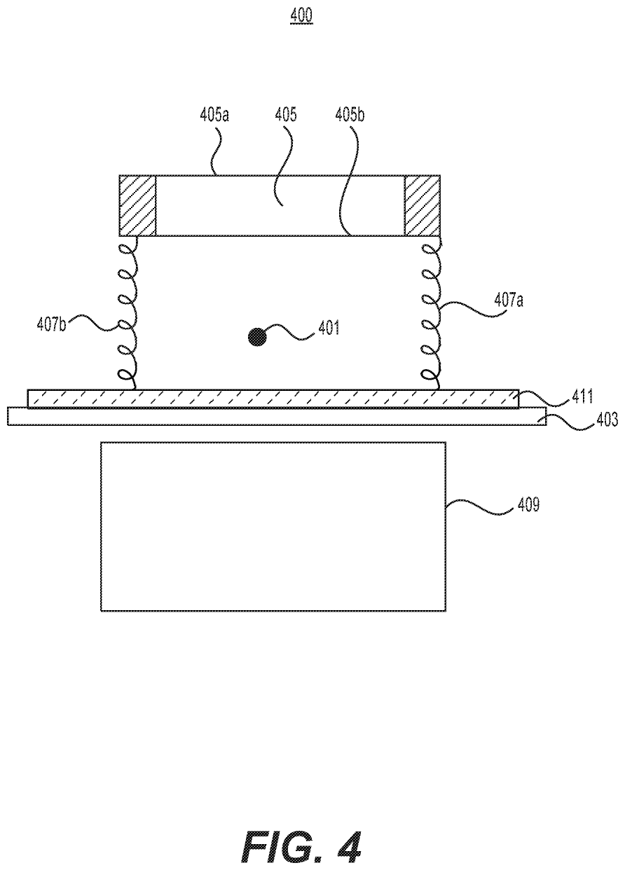

FIG. 2 depicts an exemplary fretboard 201 including a plurality of keys, e.g., keys 209a and 209b that may be used in the disclosed embodiments. In some embodiments, one or more of the keys 209 may be implemented using the exemplary key 100 of FIG. 1. In other embodiments, one or more of the keys 209 may be implemented using the exemplary key 400 of FIG. 4 (described below).

Fretboard 201 may include a plurality of frets, e.g., frets 203a and 203b. In the example of FIG. 2, fretboard 201 includes 19 frets, which is the number of frets on a standard classical guitar, however, fretboard 201 may include any number of frets in other embodiments. For example, fretboard 201 may include between 21 and 24 frets, corresponding to the number of frets on a standard electric guitar or a banjo. In other embodiments, fretboard 201 may include less than 21 frets, e.g., such as the 17 frets on a standard mandolin, the 17 or 19 frets on a tenor banjo, etc. In still other embodiments, fretboard 201 may include more than 24 frets, e.g., like some specialty models of guitars.

Fretboard 201 may have a plurality of strings, e.g., strings 211a, 211b, 211c, and 211d, suspended above it. As shown in FIG. 2, fretboard 201 includes 4 strings, which is the number of strings on a standard bass guitar or a standard tenor banjo. However, fretboard 201 may include any number of strings. For example, fretboard 201 may include 6 strings, which is the number of strings on a standard guitar, or 5 strings, which is the number of strings on a standard banjo. In other embodiments, fretboard 201 may include more than 6 strings, e.g., 8 strings on the standard mandolin, 12 strings on the 12-string guitar, etc. In still other embodiments, fretboard 201 may include less than 4 strings, e.g., 3 strings on the balalaika or 2 strings on the cigar box guitar or even 1 string.

The exemplary strings 211a, 211b, 211c, and 211d may be made of nylon or any other appropriate natural or synthetic material. In other embodiments, strings 211a, 211b, 211c, and 211d may be made of steel or may have metal windings. The strings 211a, 211b, 211c, and 211d may be connected to one or more heads, e.g., heads 207a and 207b. In some embodiments, heads 207a and 207b may be connected to a headstock 205, which in turn may be connected to the fretboard 201 using an adhesive or any other means that would be known in the art. Alternatively, headstock 205 may be integrally formed with fretboard 201, for example, using a single piece of wood, plastic, or other suitable material.

In some embodiments, heads 207a and 207b may comprise one or more machine heads. For example, a machine head may comprise a cylinder or capstan mounted on a pinion gear, a knob or peg, and a worm gear linking the cylinder or capstan to the knob or peg.

In FIG. 2, strings 211a, 211b, 211c, and 211d may be connected to a body 213 of the plucked string instrument. The ends of strings 211a, 211b, 211c, and 211d connected to the body 213 may be the opposite ends of the same strings connected to heads 207a and 207b. In some embodiments, body 213 may be made of wood, for example, carved out of a single piece of wood, e.g., as an arch-top mandolin. By way of further example, body 213 may comprise strips of wood glued together, e.g., as a round-back mandolin. In other embodiments, body 213 may be made of at least one plastic, for example, made entirely of one or more plastics or using a combination of plastic(s) and wood, e.g., as many electric guitars. In still other embodiments, body 213 may comprise a thin membrane, e.g., as used in a standard banjo. In such embodiments, body 213 may further comprise a wood and/or metal circular rim. Optionally, body 213 may comprise a backing or resonator, e.g., made of wood and/or metal.

As discussed above, exemplary fretboard 201 may include a plurality of keys, e.g., keys 209a and 209b. In some embodiments, the number of keys may equal the number of strings multiplied by the number of frets. For example, in the example depicted in FIG. 2, fretboard 201 includes four strings and nineteen frets, and fretboard 201 includes 76 different keys, each positioned at a different location where a string intersects a fret on the fretboard 201. In other embodiments, fretboard 201 may include fewer keys than the number of strings multiplied by the number of frets, e.g., so keys are positioned at only certain intersections of strings and frets on the fretboard. In some embodiments, one or more of the plurality of keys, e.g., key 209a, may be adapted to be repositioned on the fretboard, for example, by sliding or otherwise moving the key 209a up or down a corresponding string 211d, e.g., to reposition the key 209a at a different intersection of string 211d with a fret on the fretboard. In other embodiments, one or more of the plurality keys, such as key 209a, may be removable so it can be repositioned on the fretboard, e.g., at a different string-fret intersection. In yet other embodiments, fretboard 201 may include more keys than the number of strings multiplied by the number of frets.

The exemplary keys 209a and 209b may be located above corresponding frets, e.g., frets 203a and 203b, on the fretboard. Keys 209a and 209b also may be located above the plurality of strings, e.g., strings 211a, 211b, 211c, and 211d. Each of the keys 209a and 209b, when in their “pressed” positions, may be adapted to apply pressure on a string, e.g., string 211d, at the location of a fret.

Although not shown in FIG. 2, the plurality of keys 209 may be aligned with one or more magnets, such as electromagnets, which in some embodiments may be located under the fretboard 201, for example, at intersections of the strings and frets. A plurality of electromagnets (not shown) may be adapted to attract the plurality of keys, e.g., keys 209a and 209b, when energized by a control unit (not shown). The attraction between an electromagnet and a key may be configured such that less force is required to depress the key. Moreover, the attraction between the plurality of electromagnets and the plurality of keys may be further configured such that the key does not require any applied force to return to its released position.

In some embodiments including a plurality of electromagnets, the magnets may be operably connected to a control circuit (not shown). The control circuit may be adapted to control an amount and/or polarity of current applied to each electromagnet. For example, the control circuit may turn on and off one or more subsets of the electromagnets. By way of further example, the control circuit may turn on one or more subsets of the electromagnets corresponding to correct notes and/or chords and leave and/or turn the remaining set of electromagnets off. Accordingly, a user of the device may know if a played note or chord is correct based on the amount of force required to depress one or more keys.

In yet other embodiments, the control circuit may be adapted to apply current of a sufficient magnitude to one or more electromagnets such that the corresponding key may depress and/or release a string without any external force from a player. For example, the control circuit may control one or more electromagnets such that the player of the plucked string instrument may pluck or strum the strings in tempo with the control of the electromagnets such that one or more notes, chords, or songs may be played without the player having to apply pressure to strings against the frets by hand.

In some embodiments, the control circuit may be able to control the magnetic field strength applied to any of the plurality keys by adjusting the current applied to each electromagnet. For example, the control circuit may apply a smaller current to a first key 100 while applying a larger current to a second key 100. In some embodiments, the control circuit may apply larger currents to one or more of subsets of the electromagnets corresponding to correct notes and/or chords, while applying smaller currents, or currents of opposite polarity, to one or more of subsets of the electromagnets corresponding to incorrect notes and/or chords. In this manner, the player may become aware of an incorrect note and/or chord when he or she feels relatively more resistance when depressing keys 100 associated with the incorrect notes and/or chords.

In certain aspects, the control circuit may be operably connected to an external device, e.g., a smartphone, tablet, or personal computer. An external device may communicate with the control circuit to adjust the electromagnets. For example, an external device may adjust the strength of the electromagnets upward or downward depending on a “novice”/“expert” setting. By way of further example, an external device may adjust which electromagnets are on and off in order to match one or more notes, chords, or songs.

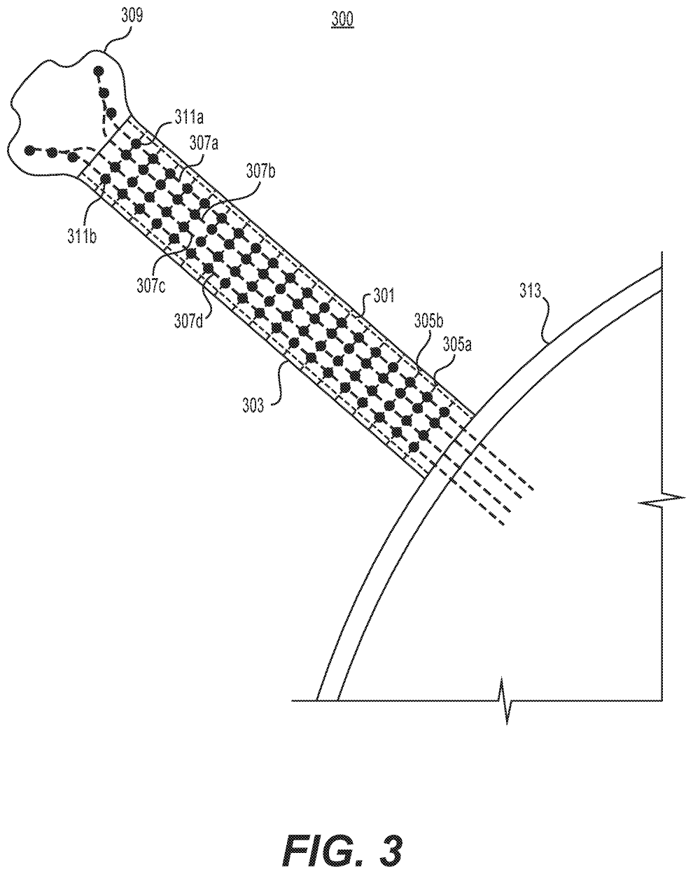

FIG. 3 depicts an exemplary fretboard cover 303 including a plurality of keys, e.g., keys 311a and 311b, connected to a fretboard 301 in accordance with certain disclosed embodiments. The exemplary fretboard cover 303 may snap onto or otherwise may be attached or positioned over the fretboard 301. In some embodiments, one or more keys in the plurality of keys 311 may be implemented using the exemplary key 100 of FIG. 1 or the exemplary key 400 of FIG. 4 (described below). The exemplary fretboard cover 303 may have a greater width and/or length than fretboard 301. In some embodiments, however, cover 303 may have a smaller width and/or length than fretboard 301.

As shown in FIG. 3, fretboard 301 may include a plurality of frets, e.g., frets 305a and 305b. For example, the exemplary fretboard 301 includes 19 frets, which is the number of frets on a standard classical guitar. However, as discussed above with reference to fretboard 201, fretboard 301 also may include any number of frets. Fretboard 301 may have a plurality of strings, e.g., strings 307a, 307b, 307c, and 307d, suspended above it. In FIG. 3, for example, fretboard 301 has 4 strings suspended above, which is the number of strings on a standard bass guitar. As discussed above with reference to fretboard 201, fretboard 301 may include any number of strings. In some embodiments, strings 307a, 307b, 307c, and 307d may be made of nylon or other appropriate natural or synthetic material. In other embodiments, strings 307a, 307b, 307c, and 307d may be made of steel or may have metal windings.

Fretboard 301 may include a headstock 309, for example, connected to the fretboard 301 with an adhesive or any other means understood in the art; alternatively, headstock 309 may be integrally formed with fretboard 301, for example, such that headstock 309 and fretboard 301 may be formed of a single piece of wood, plastic, or other suitable material.

Strings 307a, 307b, 307c, and 307d may be connected to body 313. In some embodiments, body 313 may be made of wood, such as carved out of a single piece of wood, e.g., as an arch-top mandolin. By way of further example, body 313 may comprise strips of wood glued together, e.g., as a round-back mandolin. In other embodiments, body 313 may be made of at least one plastic. For example, body 313 may be made entirely of one or more plastics or may comprise a combination of plastic(s) and wood, e.g., as many electric guitars. In still other embodiments, body 313 may comprise a thin membrane, e.g., as is used in a standard banjo. In such embodiments, body 313 may further comprise a wood and/or metal circular rim. Body 313 also may comprise a resonator, e.g., made of wood and/or metal.

In FIG. 3, the exemplary fretboard cover 303 may include a plurality of keys, e.g., keys 311a and 311b. In some embodiments, cover 303 may include a number of keys equal to the number of strings multiplied by the number of frets. In the example shown in FIG. 3, fretboard 301 includes four strings and nineteen frets, then cover 303 may include 76 keys. In other embodiments, cover 303 may include fewer keys than the number of strings multiplied by the number of frets. In some embodiments, one or more of the plurality of keys, e.g., keys 311a and 311b, may be adapted to slide or otherwise move up and down a corresponding string, e.g., string 307a or 307d, or may be removed and repositioned on the fretboard 301, e.g., at a different string-fret intersection. In such embodiments, magnet 409 may slide or otherwise move up and down with a corresponding key or keys, e.g. key 311a. In still other embodiments, cover 303 may include more keys than the number of strings multiplied by the number of frets.

Keys 311a and 311b may be located above the plurality of frets, e.g., frets 305a and 305b, and further may be located above the plurality of strings, e.g., strings 307a, 307b, 307c, and 307d. Keys 311a and 311b may be adapted to apply a force to a string, e.g., string 307a or 307d, at the location of a fret. Although not shown in FIG. 3, the plurality of keys may further include or be associated with a plurality of magnets, such as electromagnets, e.g., located underneath fretboard 301. A plurality of electromagnets may be adapted to attract one or more keys, e.g., keys 311a and 311b, such that less applied force is required to depress the key. Moreover, the attraction between the plurality of electromagnets and the plurality of keys may be configured such that the key does not require force to return to its released position.

As discussed above with reference to FIG. 2, fretboard 301 may also be connected to a control circuit (not shown). For example, the control circuit may be adapted to control electrical current within one or more electromagnets positioned behind frets of the fretboard 301 in order to adjust the magnetic-field strength of the one or more magnets, turn on and/or off the selected electromagnets, depress and/or release keys positioned above one or more strings without any additional applied force from the player, and the like. The control circuit may also be operably connected to an external device, e.g., a smartphone, tablet, or personal computer, which may communicate with the control circuit to adjust the one or more electromagnets, for example by sending instructions that the control circuit can decode, perform, or otherwise convert into signals for controlling the electromagnets. In embodiments where the control circuit includes one or more processors, the control circuit may receive software instructions or commands that it can use to control the magnets.

FIG. 4 depicts an exemplary key 400 in accordance with some of the disclosed embodiments. Exemplary key 400 may be located above a string 401 of a plucked string instrument. String 401 may be suspended above a fretboard 403 and the key 400 may be located above the string 401 at a fret of fretboard 403. The key, when depressed, may apply a force to press the string 401 against its underlying fret. Key 400 also may include a keytouch 405 with an outer surface 405a and an inner surface 405b. The outer surface 405a may be made of at least one plastic material or any other material.

Key 400 may include springs 407a and 407b or any other appropriate device or mechanism that allows key 400 to move downward to a “pressed” position, for example when force is applied to outer surface 405a, and move upward to a “released” position when the applied force is removed. Key 400 may comprise a biased switch.

The exemplary key 400 may include or be associated with a magnet 409, such as a permanent magnet or electromagnet. In some embodiments, inner surface 405b of keytouch 405 may be adapted to be attracted to magnet 409, e.g., when the magnet is an electromagnet that has been energized by a signal from a control unit (not shown). The attraction between magnet 409 and inner surface 405b may be adapted to reduce the force required to depress key 400 and may ensure key 400 remains a biased switched—that is, such that key 400 does not require any additional force to return to its released position.

In the embodiment shown in FIG. 4, key 400 may include an indicator 411, such as a visible or audible indicator that is triggered when the key is in its “pressed” position. In some embodiments, indicator 411 may be triggered using a pressure sensor configured to detect pressure on string 401 and/or on springs 407a and 407b. For example, indicator 411 may comprise a light-emitting diode that is adapted to light up when key 400 is in its pressed position. The use of a light-emitting diode may assist players with hearing impairments who cannot hear incorrect and correct notes or players with visual impairments who cannot see the strings clearly.

In other embodiments, indicator 411 may be adapted to light up when one or more keys have been pressed for a correct finger position and/or a particular chord or note on the string instrument. In embodiments including a finger cuff 500, described below, indicator 411 may be adapted to light up when a string is depressed using finger cuff 500. In some embodiments, indicator 411 may light up with one color when key 400 is in a pressed position and with a second color when key 400 is in a released position. In other embodiments, indicator 411 may light up with one color when key 400 is in a pressed position that correlates with a correct finger position and may light up with a second color when key 400 is in a pressed position that correlates with an incorrect finger position. In still further embodiments, indicator 411 may light up with one color when key 400 is in a released position that correlates with a correct finger position and may light up with a second color when key 400 is in a released position that correlates with an incorrect finger position. Other embodiments comprising any combination of these described implementations for indicator 411 are also possible.

As shown in FIG. 4, the exemplary indicator 411 may be located on fretboard 403, for example, above, below, or next to the area of fretboard 403 located underneath keytouch 405. In other embodiments, indicator 411 may be located on outer surface 405a of keytouch 405. In yet other embodiments, the indicators 411 may be implemented on a display of an external device, such as a display on a smartphone, tablet, or personal computer, to depict any type of text or graphics that communicate to the user which keys 400 have been depressed. The display may be a touchscreen display. The display may be adapted to indicate whether the player has used the correct finger position for a note or chord of the plucked string instrument. In some embodiments, such a display may be used in addition to using indicators 411 that are positioned above, below, or next to areas of the fretboard 403 located underneath keytouches 405. In certain embodiments, the display may be integrated with the fretboard or other portion of the plucked string instrument, e.g., to indicate whether the player has used the correct finger position for a note or chord of the plucked string instrument.

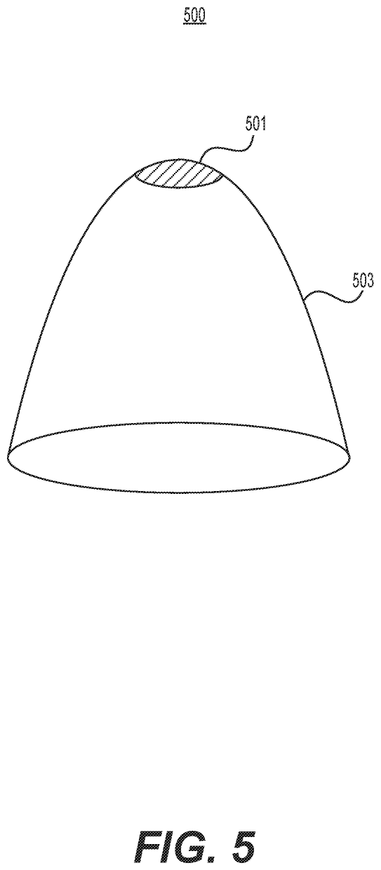

FIG. 5 depicts an exemplary finger cuff 500 that may be used in accordance with certain disclosed embodiments. Although depicted as a single finger cuff 500, other embodiments may use multiple finger cuffs, for example, implemented in a partial glove including one or more finger cuffs or a full glove including one or more finger cuffs. Finger cuff 500 may include a metal portion 501, preferably located near the player's fingertip when the finger cuff is worn, comprising at least some metal material that can be attracted to a magnet 109 or 409. For example, metal portion 501 may include a ferromagnetic material, such as iron, nickel, or cobalt. Metal portion 501 may optionally be omitted from finger cuff 500.

In some embodiments, finger cuff 500 may include a malleable body portion 503, for example, made of silicone, rubber, or plastic. Alternatively, finger cuff 500 may be formed using a single material, for example, a polymer material including at least some metal material, such as metal particles, at least in the metal portion 501. The finger cuff 500 may have a generally conical shape, and the metal portion 501 may be located at or near a tip of the conical shape. The size and shape of finger cuff 500 may vary and be adapted for particular sizes and shapes of fingers. For example, finger cuff 500 may be larger if adapted for larger fingers, longer if adapted for longer fingers, etc. The thickness of finger cuff 500 may also vary. For example, the thickness may be increased for less advanced players, e.g., to increase comfort during playing.

The metal portion may be formed in a region of the body portion 503 or may be constructed as a separate element that can be integrated into or may be attached to the body portion. The finger cuff 500 may be placed on any finger, including a thumb, of a player of a plucked string instrument. In some embodiments, finger cuff 500 may have a length that is no longer than the distance between a tip of a finger and a first joint of the finger of the player.

In some embodiments, metal tip 501 may be adapted to be attracted to magnet 109 of key 100 or magnet 409 of key 400. In such embodiments, finger cuff 500 may obviate the need for either keytouch 105 or keytouch 405. In these embodiments, the keys 100 and 400 also would not include any springs or spring-like mechanisms 107a and 107b or 407a and 407b, since there would not be any keytouch 105 or 405 to support.

In some embodiments, indicator 411 of key 400 may be adapted to function with finger cuff 500. For example, indicator 411 may be adapted to light up when finger cuff 500 depresses a string at a certain location, e.g., over a magnet 409. In other embodiments, indicator 411 may be adapted to light up such that a correct finger position for a chord or note is indicated. In certain embodiments, indicator 411 may light up with one color when finger cuff 500 depresses a string against a fret at a certain location and with a second color when finger cuff 500 releases and/or does not depress a string against a fret at a certain location. In further embodiments, indicator 411 may light up with one color when finger cuff 500 depresses a string against a fret in a location that correlates with a correct finger position and may light up with a second color when finger cuff 500 depresses a string against a fret in a location that correlates with an incorrect finger position. In still further embodiments, indicator 411 may light up with one color when finger cuff 500 releases a key and/or does not depress a string against a fret in a location that correlates with a correct finger position and may light up with a second color when cuff 500 releases and/or does not depress a string against a fret in a location that correlates with an incorrect finger position. Other embodiments may employ any combination of one or more of these implementations described above.

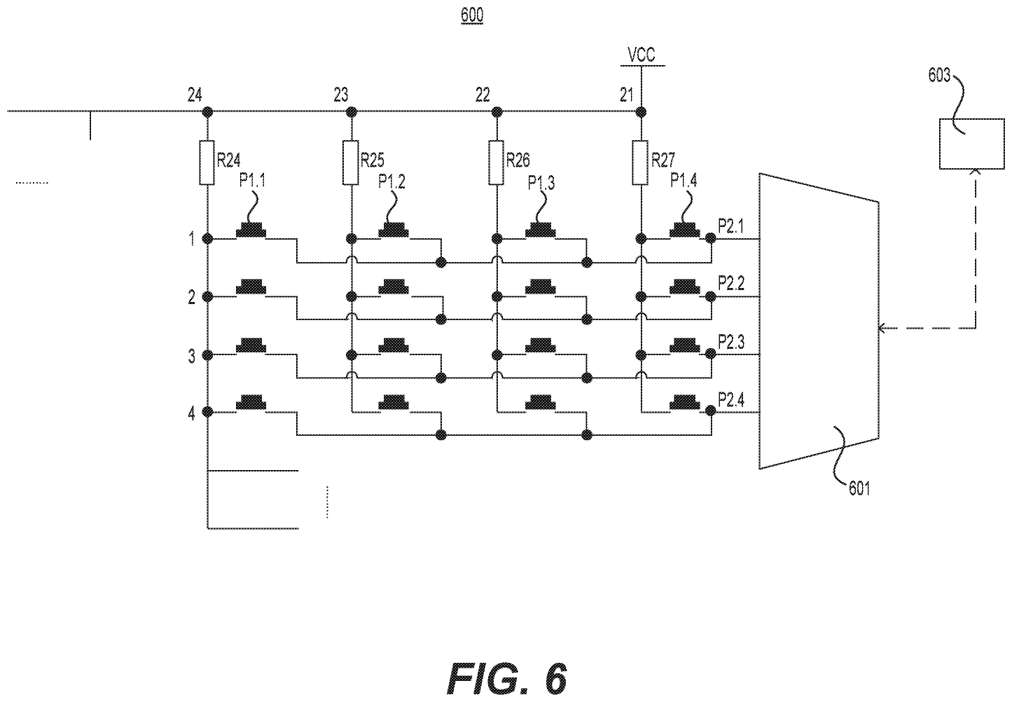

FIG. 6 is a schematic diagram of an exemplary control circuit 600 that may be used in accordance with certain disclosed embodiments. For example, control circuit 600 may be adapted to function with fretboard 201 of FIG. 2 or with fretboard 301 of FIG. 3. The control circuit 600 may include a voltage source (VCC) and a plurality of resistors, e.g., resistors R24, R25, R26, and R27. Each resistor may correspond to a fret on the fretboard. In some embodiments, the resistors may have the same resistance. In other embodiments, the resistors may have different resistance values.

As shown in FIG. 6, one or more electrical paths, for example, paths 1, 2, 3, and 4, may be implemented under or within the fretboard and may run parallel to corresponding strings suspended above the fretboard. If the fretboard includes keys, e.g., key 100 of FIG. 1 or key 400 of FIG. 4, the keys may function as the switches, e.g., P1.1, P1.2, P1.3, and P1.4, in the electrical paths shown in the exemplary control circuit of FIG. 6. In such embodiments, every time a key is depressed, it closes a switch, such as P1.1, P1.2, P1.3, or P1.4, which then applies a higher voltage or current along the path 1, 2, 3, or 4 containing the closed switch. The voltage or current generated by depressing a key (i.e., also a switch in this exemplary embodiment) may be applied to an input, e.g., P2.1, P2.2, P2.3, or P2.4, of a voltage or current sensing circuit 601. The circuit 601 may determine which key was depressed, which string was depressed, and/or at which fret the string was depressed, based on the voltage or current it receives at its inputs. For example, circuit 601 may determine which string was depressed based on which of its inputs P2.1, P2.2, P2.3, or P2.4 receives a higher voltage and/or current level. By way of further example, if resistors R24, R25, R26, and R27 have different resistances, circuit 601 may determine at which fret the string was depressed based on the level of voltage and/or current received at the inputs, e.g., P2.1, P2.2, P2.3, and P2.4. Circuit 601 may be implemented as a part of a larger processor or may be a separate circuit, module, or processor that coordinates with one or more other processors (not shown). Further, circuit 601 may consist of one or more circuits that collectively operate to sense when a string, key, and/or switch has been depressed.

As depicted in FIG. 6, sensing circuit 601 may be operably connected to an external device 603. For example, a smartphone, tablet, personal computer, or any other device may function as external device 603 and may be used to receive and decode the electrical current or voltage generated when a string, key, and/or switch is depressed. For example, exemplary sensing circuit 601 may cause a signal to be sent to the external device whenever a key is depressed. In some embodiments, the connected device 603 also may be used in connection with one or more additional control circuits configured to turn on/off and/or change the color of any indicators included in the keys or to adjust the level of current in one or more electromagnets.

External device 603 may display guidance for playing the stringed instrument. In some embodiments, the guidance may be visual, for example, colored markers or other indicators corresponding to notes and/or chords being played or to be played.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A device for providing assistance to operating a plucked string instrument, the plucked string instrument having a fretboard with a plurality of strings suspended over the fretboard, the device comprising:
a key positioned above a string of the plurality of strings and attachable to the fretboard, the key configured to apply a force to the string when the key is depressed; and
at least one magnet located under the key and configured to generate a magnetic field that reduces an amount of force required to depress the key without the at least one magnet,
wherein the device is implemented in a fretboard cover configured for attachment to the plucked string instrument or the device is integrated into the plucked string instrument.

2.-4. (canceled)

5. The device of claim 1, further comprising:
one or more indicators, wherein each indicator is configured to indicate whether a predetermined note or chord of the plucked string instrument is played.

6. The device of claim 5, wherein the one or more indicators comprises at least one light-emitting diode.

7. The device of claim 1, further comprising:
a display configured to provide a visual indication of whether a player has used a correct finger position for a note or chord of the plucked string instrument.

8. The device of claim 1, wherein the key is configured to move along the string of the plucked string instrument.

9. The device of claim 1, wherein the at least one magnet includes at least one electromagnet, and the device further comprises:
a control circuit configured to selectively apply a current to the at least one electromagnet to generate a magnetic field that assists with the depression of the key.

10. The device of claim 9, wherein the at least one electromagnet is configured to generate a magnetic field that depresses the key without force applied by a player.

11. The device of claim 1, further comprising:
a circuit configured to detect when the key has been depressed.

12. The device of claim 11, wherein the circuit is further configured to:
connect to an external device, and
send a signal to the external device when the key is depressed.

13. The device of claim 12, wherein the external device is at least one of a smartphone or a tablet.

14. A plucked string instrument, comprising:
a fretboard having a plurality of frets located under a plurality of strings;
at least one key located above the plurality of strings and attachable to the fretboard, each key configured to apply a force to a string of the plurality of strings at a location of a fret of the plurality of frets when the key is depressed; and
at least one magnet located under the at least one key and configured to generate a magnetic field that reduces an amount of force required to depress the at least one key.

15.-16. (canceled)

17. The plucked string instrument of claim 14, wherein the at least one magnet is integrated between a bottom side and a top side of the fretboard or is located underneath the fretboard.

18. (canceled)

19. The plucked string instrument of claim 14, further comprising:
one or more indicators, wherein each indicator is configured to activate based on whether a player presses one or more keys corresponding to a correct finger position for a note or chord of the plucked string instrument.

20. (canceled)

21. The plucked string instrument of claim 14, further comprising:
a display integrated with the fretboard and configured to indicate whether a player has used a correct finger position for a note or chord of the plucked string instrument.

22. (canceled)

23. The plucked string instrument of claim 14, wherein the at least one magnet includes at least one electromagnet, and the device further comprises:
a control circuit configured to selectively apply a current to the at least one electromagnet to generate a magnetic field that assists with the depression of the at least one key.

24. (canceled)

25. The plucked string instrument of claim 14, further comprising:
a circuit configured to detect when the at least one key has been depressed.

26.-27. (canceled)

28. A finger cuff configured to fit over a finger of a player, the finger cuff comprising:
a metal tip portion configured to be positioned near a finger tip of the player when the player wears the finger cuff; and
a non-metal body portion adjacent to the tip portion.

29. The finger cuff of claim 28, wherein the body portion comprises silicone or the tip portion comprises a ferromagnetic material.

30. (canceled)

31. The finger cuff of claim 28, wherein the body portion has a length not longer than the distance between a tip of a finger and a first joint of the finger of the player.

32. The device of claim 1, wherein the at least one magnet is located underneath the fretboard or within the fretboard.
